(19) United States
(12) Patent Application Publication
(10) Pub. No.: US 2007/0114863 A1
(43) Pub. Date: May 24, 2007

(54) BRUSHLESS MOTOR

(75) Inventors: Tatsuya Shimoyama, Kyoto (JP); Masaaki Mano, Kyoto (JP)

Correspondence Address: NIDEC CORPORATION;c/o KEATING & BENNETT, LLP, 8180 GREENSBORO DRIVE, SUITE 850, MCLEAN, VA, 22102, US

(73) Assignee: NIDEC CORPORATION, Minami-ku (JP)

(21) Appl. No.: 11/561,925

(22) Filed: Nov. 21, 2006

(30) Foreign Application Priority Data
Nov. 22, 2005 (JP) 2005-337878

(51) Int. Cl. H02K 7/00; H02K 7/10; H02K 5/16

(52) U.S. Cl. 310/90; 310/83; 310/67 R; 310/261

(57) ABSTRACT

A shaft of a brushless motor includes a protruding portion, and a ball bearing abutting against the protruding portion for axially positioning the ball bearing. The protruding portion is formed by rolling, and a plurality of protruding portions are arranged on the shaft in a circumferentially equally spaced manner. By forming the protruding portions by rolling, durability of the shaft against a force in a radial direction is enhanced, and therefore, it is possible to provide a reliable brushless motor.

### BACKGROUND OF THE INVENTION

1. Field of the Invention

The present invention generally relates to a brushless motor equipped with a roller bearing.

2. Description of the Related Art

A roller bearing is used for a brushless motor to obtain a highly reliable and durable brushless motor. In such a brushless motor, the roller bearing is axially positioned by abutting against an annular step provided on a shaft of the brushless motor. In another example, the roller bearing is abutted against an annular member arranged on the shaft for axially positioning the roller bearing. It is also known that a plurality of swells each having a doughnut shape are provided on the shaft for axially positioning the roller bearing by abutting the roller bearing against the swells.

Recently, a brushless motor having a competitive price and reliable performance is in demand. However, the conventional method of providing the annular step on the shaft does not meet the demand in terms of a cost for processing the shaft. Similarly, upon using the annular member for axially positioning the ball bearing, it is necessary to provide an annular groove on the shaft to arrange the annular member in a predetermined position. Such an additional component (i.e., the annular member) and additional processing procedures drive up the price of the brushless motor.

The plurality of the doughnut shape swells are conventionally formed by pressurizing a portion of the shaft surface to be deformed around the pressurized portion. As a result of the pressurization, the holes and the swells arranged around the holes are formed on the shaft. When force directed in a radial direction is applied to the shaft, stress is concentrated at portions in which holes are provided. Especially when a gear which engages with a gear wheel of another device is arranged on a bottom end of the shaft, an excessive force directed in the radial direction is applied to the shaft. Therefore, as a result of the long duration of driving the brushless motor, the shaft may be damaged.

### SUMMARY OF THE INVENTION

In order to overcome the problems described above, preferred embodiments of the present invention provide a reliable and durable brushless motor. In addition, manufacturing of the brushless motor is effectively facilitated.

According to a preferred embodiment of the present invention, the protruding portion is formed on the shaft by a rolling process. According to another preferred embodiment of the present invention, a plurality of protruding portions may be circumferentially arranged on the shaft in an equally circumferentially spaced manner. The protruding portion protrudes radially outwardly from about 3% to about 5% of an outer diameter of a portion of the shaft where the ball bearing is attached. By virtue of this configuration, the manufacturing process of the motor is facilitated, and the durability of the shaft is preferably maintained. Additionally, axial positioning of the ball bearing is facilitated.

According to another preferred embodiment of the present invention, the gear is provided on an axial end portion of the shaft. The gear is arranged axially outside of the motor, and the protruding portion is provided axially between the gear and the ball bearing. Upon providing the gear on the end portion of the shaft, a force in the radial direction is applied to the shaft and stress is concentrated on a portion near where the protruding portion is arranged. In the present preferred embodiment of the present invention, the protruding portion is formed by rolling and the durability of the portion of the shaft is preferably maintained.

According to another preferred embodiment of the present invention, a plurality of ball bearings are arranged in an axially spaced manner, and at least one ball bearing arranged near the gear is secured to the shaft by press-fitting. By virtue of this configuration, a reliable and durable motor is provided.

Other features, elements, steps, processes, characteristics and advantages of the present invention will become more apparent from the following detailed description of preferred embodiments of the present invention with reference to the attached drawings.

### BRIEF DESCRIPTION OF THE DRAWINGS

FIG. 1 is a schematic sectional view illustrating a brushless motor according to a preferred embodiment of the present invention.

FIG. 2A is a magnified view illustrating a tip end portion of the shaft and a ball bearing provided on the brushless motor according to the present preferred embodiment of the present invention.

FIG. 2B is a magnified view illustrating a tip end portion of a shaft and the ball bearing provided on a brushless motor according to the conventional art.

FIG. 3 illustrates a cross section of the shaft along a line X-X line shown in FIG. 2A.

FIG. 4A is a magnified view illustrating a tip end portion of the shaft and a ball bearing provided on the brushless motor according to another preferred embodiment of the present invention.

FIG. 4B illustrates a cross section of the shaft along a line Y-Y shown in FIG. 4A.

### DETAILED DESCRIPTION OF PREFERRED EMBODIMENTS

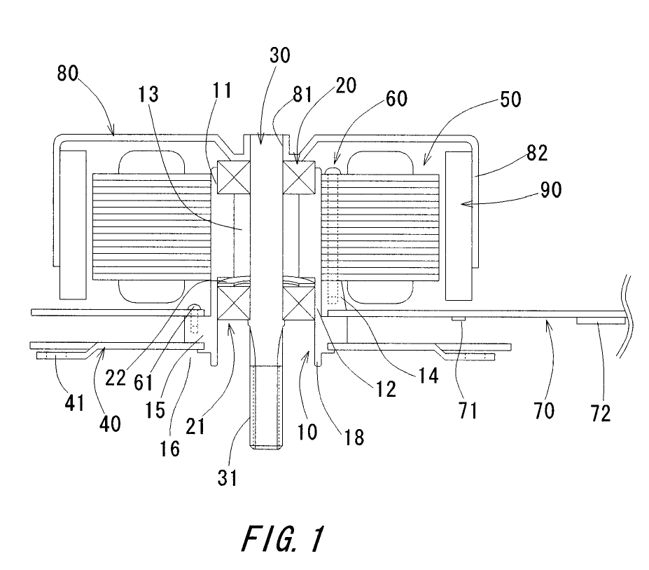

Referring to FIGS. 1 to 4B, a brushless motor according to preferred embodiments of the present invention will be described in detail. It should be understood that in the explanation of the present invention, when positional relationships among and orientations of the different components are described as being such as top/bottom, up/down or left/right, positional relationships and orientations that are in the drawings are indicated, and positional relationships among and orientations of the components once having been assembled into an actual device are not indicated. Additionally, in the following description, an axial direction indicates a direction parallel to a rotation axis, and a radial direction indicates a direction perpendicular to the rotation axis.

Configuration of the Brushless Motor

Referring to FIG. 1, the configuration of the brushless motor according to a preferred embodiment of the present invention will be described in detail.

A bearing holder 10 has a substantially cylindrical shape with a through hole at a middle portion thereof. The bearing holder 10 is preferably formed by aluminum or zinc die casting. The bearing holder 10 includes an upper step portion 11 which is an upper portion of the bearing holder having an axially upwardly facing recess and a bottom step portion 12 which is a bottom portion of the bearing holder having an axially downwardly facing recess. An upper ball bearing 20 is arranged in the upper step portion 11, and a bottom ball bearing 21 is arranged in the bottom step portion 12. A substantially cylindrical shaft 30 is inserted into a hollow portion 13 of the bearing holder 10 and center openings of the ball bearings 20 and 21. By virtue of the configuration described above, the shaft 30 is rotatably supported by the ball bearings 20 and 21. The bottom ball bearing 21 has a first axial side (i.e., an axially upper side) and a second axial side (i.e., an axially lower side), and a resilient member 22, such as an O-shape spring washer, is arranged axially between the first axial side of the bottom ball bearing 21 and the bearing holder 10. The resilient member 22 supports a radially outward portion of the bottom ball bearing 21 and applies a pre-load to the ball bearing 21.

A gear 31 defined by any suitable gear wheel such as a helical gear is arranged on a bottom portion of the shaft 30. The gear 31 is formed on a bottom portion of the shaft 30. The gear 31 may be provided integrally with, or separately from, the bottom portion of the shaft 30. The gear 31 is engaged with another gear wheel provided on a device to which the brushless motor is installed, and therefore, torque generated by the brushless motor is transferred to the device.

In this preferred embodiment of the present invention, three first convex portions 14 and three second convex portions 15 are arranged radially outside of a bottom portion of the bearing holder 10. The first convex portions 14 are axially upwardly arranged from the second convex portions 15. The first convex portions 14 are arranged in an equally circumferentially spaced manner (i.e., at about 120°), and the second convex portions 15 are arranged in the same manner.

An attaching board 40 is arranged at a bottom end portion 16 of the bearing holder 10. The attaching board 40 is processed by a method such as press working of a steel plate and is secured to the bottom end portion 16 by caulking, for example, or other suitable method. The attaching board 40 includes a mounting hole 41 used for mounting the brushless motor on an electronic device. The bearing holder 10 includes an annular convex portion 18 protruding axially downwardly from the bottom end portion 16 of the bearing holder 10. The annular convex portion 18 is used for axial positioning of the brushless motor against the device to which the brushless motor is installed.

A stator 50 having an annular shape is abutted against and secured to an upper surface of a first convex portion 14 and an outer circumferential surface of a cylindrical body of the bearing holder 10. In this preferred embodiment of the present invention, the first convex portion 14 includes a threaded hole, and the stator 50 includes a through hole which is axially aligned with the threaded hole. A screw 60 is inserted into and passes through the through hole, and is tightened to the threaded hole to secure the stator 50. A circuit board 70, such as a paper-phenol board, is secured to an upper surface of the second convex portion 15 by a screw 61. The circuit board 70 includes a hall element 71 which detects a rotation speed of the brushless motor, and an integrated circuit (IC) 72 which processes a signal generated by the hall element 70.

A rotor holder 80 having a substantially hollowed cylindrical shape is formed by such method as press working of the steel plate. The rotor holder 80 includes a hollow portion 81, and an upper end portion of the shaft 30 is secured to the rotor holder 80 by press-fitting (i.e., the shaft 30 is pressed into the hollow portion 81 and secured by friction after the parts are pushed together) The rotor holder 80 and the shaft 30 are arranged to be coaxial with the stator 50 and radially covering the stator 50. Furthermore, a substantially annular rotor magnet 90 is arranged at an inner surface of a cylindrical body 82 of the rotor holder 80 in a manner coaxial with the shaft 30 and radially facing the stator 50. The rotor magnet 90 is secured to the cylindrical body 82 with an adhesive or the like.

When electricity is provided to the stator 50, the stator 50 generates a magnetic field which interacts with the rotor magnet 90. The interaction between the rotor magnet 90 and the magnetic field generates torque which rotates the brushless motor. In this preferred embodiment of the present invention, the bearing holder 10 and the stator 50 may be collectively referred to as a stationary member, and the rotor holder 80 and the rotor magnet 90 may be referred to as a rotor member. However, it should be noted that the components of the rotor member and/or the stationary member may be changed in accordance with a motor configuration.

Shaft and Bearing

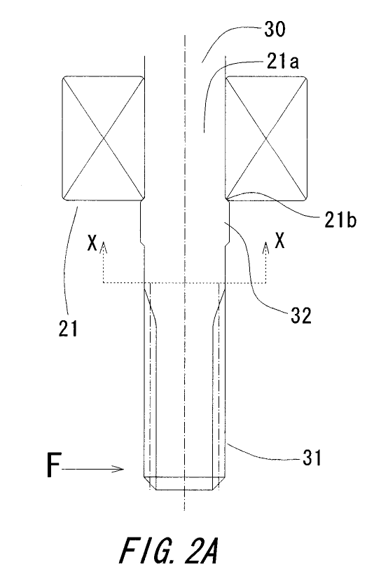

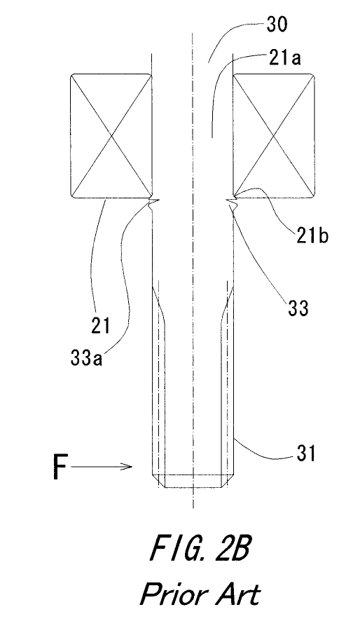

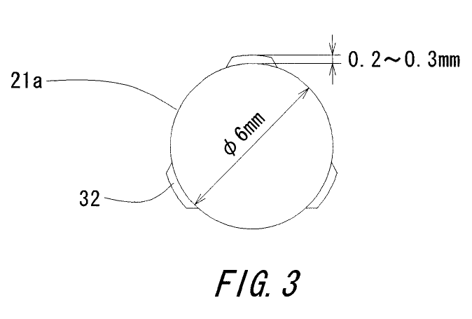

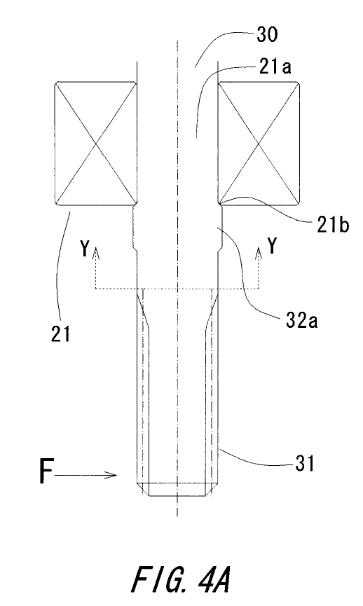

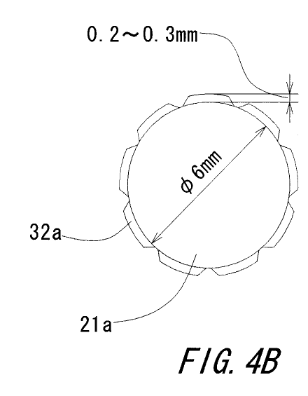

Referring to FIGS. 2A to 4B, the shaft 30 and the ball bearing 21 according to the present preferred embodiment of the present invention will be described in detail. FIGS. 2A and 2B are magnified views illustrating a tip end portion of the shaft 30 and the ball bearing 21. FIG. 2A illustrates a preferred embodiment of the present invention, and FIG. 2B illustrates the conventional art. FIG. 3 illustrates a cross section of the shaft 30 along a line X-X shown in FIG. 2A. FIGS. 4A and 4B illustrate another preferred embodiment of the present invention. FIG. 4B illustrates a cross section of the shaft 30 along a line Y-Y shown in FIG. 4A.

As illustrated in FIG. 2A, the shaft 30 includes a plurality of protruding portions 32 circumferentially arranged at a position axially upward from the gear 31 of the shaft 30. The axially second side of the bottom ball bearing 21 is abutted against the protruding portions 32 such that the ball bearing 21 and the shaft 30 are axially positioned. The protruding portions 32 are formed by rolling with a rolling mill such as knurling. Through the rolling process, the protruding portion is formed so as to extend in substantially circumferential and axial directions and not to include a recess extending radially inwardly into the shaft. By virtue of the configuration, the durability of the shaft 30 against the force directed in the radial direction is increased. Generally the durability of the shaft 30 is decreased through the cutting work. In the preferred embodiment of the present invention, however, the durability of the shaft 30 is increased through the rolling process.

When the gear 31 provided on the bottom portion of the shaft 30 engages with the gear wheel of the device, the force F directed in a radial direction illustrated in FIGS. 2A and 2B by arrows is applied to a bottom end portion of the shaft 30. Therefore, stress is concentrated around the portion below ball bearing 21. Without the protruding portions 32, the shaft 30 may be damaged or broken by the force F at the bottom end portion. In the present preferred embodiment of the present invention, however, the protruding portions 32 formed by rolling are provided on the portion below the ball bearing 21. Consequently, the durability of the shaft 30 is increased. Moreover, since the protruding portions 32 are formed by rolling, no burrs are produced during a forming process of the protruding potions 32. By virtue of this configuration, it is possible to provide a reliable brushless motor.

As illustrated in FIG. 2B, conventional protruding portions 33 are provided on the shaft by forming a hole 33a so as to deform a portion of the shaft surface. When the force F is applied, stress is concentrated at the portions where the holes are provided. As a result, the shaft may be damaged.

As illustrated in FIG. 3, the protruding portions 32 may protrude in the radial direction by about 3% to about 5% of an outer diameter of a bearing support portion 21a of the shaft 30, arranged radially inward from the ball bearing 21. By virtue of this configuration, the ball bearing 21 is axially positioned while a bottom surface of the ball bearing 21 is maintained substantially perpendicular to the shaft 30. If the protruding portions 32 protrude less than about 3% of the outer diameter of the bearing support portion 21a, the protruding portions 32 may extend into a curved, or chamfered, portion 21b of the ball bearing(shown in FIG. 2A). As a result, the ball bearing 21 may not be positioned axially and/or the bottom surface of the ball bearing 21 may be slanted. If the protruding portions 32 are formed to protrude more than about 5% of the outer diameter of the bearing support portion 21a, an excessive force, which degrades deflection accuracy and/or roundness of the shaft 30, is applied to the shaft 30. Additionally, in order to form such protruding portions, a strong force is applied to a chucking tool which holds the shaft 30 during the rolling process. As a result of such a force, the chucking tool may be broken or damaged. With the protruding portions radially protruding in the range of about 3% to about 5% of the bearing supporting portion 21a, it is possible to axially position the ball bearing 21 while preferably keeping the deflection accuracy and/or roundness of the shaft 30. p In this preferred embodiment of the present invention, the outer dimension of the bearing support portion 21a is about 6 mm, i.e., the protruding portions protrude from about 0.2 mm to about 0.3 mm in the radial direction. Generally, the radial width of the curved portion of the ball bearing is less than about 0.2 mm.

In the above preferred embodiments of the present invention, a cross section in the radial direction of the protruding portion preferably has a substantially trapezoidal shape. However, the shape of the protruding portion may be semicircular, triangular, or the like.

In the preferred embodiments of the present invention, three protruding portions 32 are provided as shown in FIG. 3. However, the number of the protruding portions 32 provided on the shaft is not limited thereto. Moreover, the protruding portions may be formed by any suitable rolling process. For example, as shown in FIG. 4B, a plurality of protruding portions 32a may be formed on the shaft by knurling or thread rolling.

While the present invention has been described above with respect to the preferred embodiments, it is to be understood that variations and modifications will be apparent to those skilled in the art without departing the scope and spirit of the present invention. The scope of the present invention, therefore, is to be determined solely by the following claims.

What is claimed is:

1. A motor comprising:
a rotational shaft;
a ball bearing rotatably supporting the rotational shaft;
a bearing holder supporting the ball bearing and having an inner circumferential surface defining a substantially cylindrical hole to which the rotational shaft is inserted;
a step portion protruding radially inwardly from the inner circumferential surface of the bearing holder and supporting the ball bearing from a radial outside and a first axial side thereof;
a protruding portion formed on the rotational shaft by rolling and abutting against the ball bearing on a second axial side of the ball bearing, the protruding portion extending in substantially circumferential and axial directions and not including a recess extending radially inwardly into the shaft;
a stator arranged radially outside of the bearing holder;
a rotor holder mounted to the rotational shaft in a coaxial manner and rotating with rotation of the rotational shaft; and
a rotor magnet arranged on the rotor holder and having a radial inner surface facing a radial outside surface of the stator.

2. The motor as set forth in claim 1, wherein a plurality of protruding portions are arranged on the rotational shaft in a circumferentially equally spaced manner.

3. The motor as set forth in claim 1, wherein the ball bearing includes a chamfered portion on a radial inner portion of the second axial side of the ball bearing, and the protruding portion abuts against the ball bearing at a portion radially outside the chamfered portion.

4. The motor as set forth in claim 3, wherein the protruding portion protrudes radially outwardly from about 3% to about 5% of an outer diameter of a portion of the rotational shaft where the ball bearing supports the rotational shaft.

5. The motor as set forth in claim 1, wherein a gear is provided on an end portion of the rotational shaft axially outside of the bearing holder, and the protruding portion is arranged axially between the ball bearing and the gear.

6. A motor comprising:
a rotational shaft;
a gear formed integral with or separated from the rotational shaft, the gear is arranged on an axial end portion of the rotational shaft;
a ball bearing rotatably supporting the rotational shaft;
a stationary member supporting the ball bearing;
a rotor member rotating with the rotational shaft; and
a protruding portion axially abutting against the ball bearing, the protruding portion extending in substantially circumferential and axial direction and not including a recess extending radially inwardly into the shaft; wherein
the gear is arranged axially outside of the stationary member, and the protruding portion is arranged on a portion of the rotational shaft axially between the gear and the ball bearing.

7. The motor as set forth in claim 6, wherein a plurality of the protruding portions are arranged on the rotational shaft in a circumferentially equally spaced manner.

8. The motor as set forth in claim 6, wherein the ball bearing includes a chamfered portion on a radially inner portion of a first axial side of the ball bearing, and the protruding portion abuts against the ball bearing at a portion radially outside the chamfered portion.

9. The motor as set forth in claim 8, wherein the protruding portion protrudes radially outwardly from about 3% to about 5% of an outer diameter of a portion of the rotational shaft where the ball bearing supports the rotational shaft.

10. The motor as set forth in claim 6, wherein the protruding portion is formed on the rotational shaft by rolling.

11. The motor as set forth in claim 1, wherein a plurality of the ball bearings are arranged in an axially spaced manner, and at least one ball bearing is arranged near where the gear is press-fit to the rotational shaft.
